(19) United States
(12) Patent Application Publication
(10) Pub. No.: US 2012/0282972 A1
(43) Pub. Date: Nov. 8, 2012

(54) UPLINK POWER CONTROL

(75) Inventors: Bjorn Folkstedt, Molndal (SE); Par Ankel, Nodinge (SE); Jan Lindskog, Pixbo (SE)

(73) Assignee: Telefonaktiebolaget L M Ericsson (publ), Stockholm (SE)

(21) Appl. No.: 13/511,796

(22) PCT Filed: Nov. 26, 2009
(86) PCT No.: PCT/EP2009/065891

§ 371 Date: May 24, 2012

(51) Int. Cl. H04W 52/40

(52) U.S. Cl. 455/522

(57) ABSTRACT

A method for a first base station (BS1) and a base station are provided being adapted to receive uplink transmissions at transmission opportunities from a given user entity (UE). The method comprises the steps of detecting whether the following conditions I-III are all found to exist I—whether a transmission from a given user entity is received on a transmission opportunity (10, 20), II—whether an overload situation exists in the base station, III—whether the base station is in a state of soft handover with regard to receiving an expected transmission from the given user entity, and if conditions 1-111 are all found to exist, at least refraining (24) from issuing a power down (DOWN) signal, wherein the refraining (24) from issuing a power down signal (DOWN) is performed although the signal to interference (SIR) level may be above a predefined first level nor-mally giving rise to issuing a power down (DOWN) signal.

### TECHNICAL FIELD

The invention relates to uplink power control for point to multipoint wireless communication in which soft handover and/or softer handover may be utilized. More specifically, the invention relates to a base station operating according to the high speed uplink HSUPA standard and a method for such a base station.

### BACKGROUND

The 3rd Generation Partnership Project (3GPP) has standardized a third generation (3G) mobile phone system called Wideband Code Division Multiple Access (WCDMA) within the International Telecommunication Union (ITU). In release 6 of the 3GPP WCDMA specification, the standard was extended to include a feature denoted Enhanced Uplink (EUL) that increases the uplink speed and reduces the delays in the uplink. EUL is based upon an uplink transport channel called the Enhanced Dedicated Channel (E-DCH). An overview of EUL can be found in the 3GPP document 25.309 and in WCDMA Enhanced Uplink—Technical Description EAB-04:013098. EUL with its ability to quickly reallocate available bandwidth between wireless end users is well addressed to meet packet data applications with its large and rapid variation in their bandwidth requirements.

### Transmit Power Control

In a WCDMA system, the transmit power from the User Equipments (UEs) is controlled with two Transmission Power Control (TPC) algorithms defined in the 3GPP standard. These two algorithms are called the inner and the outer loop power control. The 3GPP document 25.214 describes this power control in detail and the parts relevant for this invention are shortly described in this document.

Soft Handover

A main benefit of E-DCH is the ability to perform soft handover, which involves “simultaneous” data reception in each involved Node-B of an uplink signal from one given user equipment. In an environment with many transmitting user equipments, this is made possible by each involved Node-B controlling the power of the uplink transmission for a given user equipment. Each connection between a UE and a cell carrier is called a radio link and the set of all radio links connected to the same UE is called the active set. I.e. the active set consists of one or several radio links. Each Node-B can have one or several radio link sets that are connected to the same UE. A radio link set is a set of one or several radio links.

### The Outer Loop Power Control

The purpose of the outer loop power control algorithm is to control the transmissions from the UEs in the uplink to ensure that they have their service maintained with a certain quality while trying to minimize the interference level in the uplink and hence maximize the capacity of the network. This is achieved with the Radio Network Controller (RNC) that sets a Signal to Interference Ratio (SIR) target that the Node-Bs shall aim at using the inner loop power control, described in the following section. It is the responsibility of the RNC to adjust the SIR target up or down whenever necessary so that the desired quality can be maintained with the lowest possible uplink interference. The desired quality can for instance be measured in terms of number of block errors in the decoded data or the number of necessary Hybrid Automatic Repeat Request (HARQ) retransmissions on an E-DCH.

FIG. 1 is a schematic overview of the connections between the RNC, two Node-Bs with three cell carriers each and a UE. The RNC is connected to the core network via The Iu interlace and the Node-B's are connected via the Iub interface to the RNC, while the UEs are connected to the Node-B's via the Uu interface. FIG. 1 shows an example where the UE is connected to one Node-B 1 through its cell carrier 1 and to another Node-B 2 through its cell carrier 4. The RNC is sending the SIR target that each radio link set within the Node-Bs are aiming for. FIG. 1 shows that the RNC controls the SIR Target level used for each radio link within a Node-B.

### The Inner Loop Power Control

For each radio link set within the active set the Node-Bs shall estimate the of the received uplink Dedicated Physical Channel (DPCH) or Fractional Dedicated Physical Channel (F-DPCH) in each slot. If the estimated SIR is above the SIR target value that the RNC has defined (see the Outer Loop Power Control section), the Node-B shall transmit the TPC command “0” in the downlink. If the estimated SIR is below the SIR target, the Node-B shall transmit the TPC (Transmit Power Control) command “1” in the downlink. If there are more than one radio link (reception in more than one cell) within a Node-B and they all belong to the same radio link set, then all Dedicated Physical Control Channels (DPCCH) from all concerned radio links shall be combined and the SIR level is measured and compared with the SIR target value and one common TPC command is sent on the downlink DPCH or F-DPCH in all the cells of the radio link set in that Node-B. If there is more than one radio link set that resides within one Node-B, then the Node-B can either combine the radio link sets within the Node-B and send one common TPC command to the UE or the radio link sets can be treated independently which might result in different TPC commands being sent to the UE. The UE on its side shall derive one single TPC command from the one or several TPC commands sent from the cells in the active set. 3GPP states that the UE shall support two different algorithms for deriving the TPC command. Higher layers are choosing which algorithm to use.

The first and most commonly used algorithm, called algorithm 1 in 3GPP, is evaluated once every slot (1500 times per second) and is based on a function y that has the soft decisions of the TPC commands sent from each radio link set, W1, W2, WN as input. This algorithm will make the UE go one step up in power or one step down each slot. The second algorithm, called algorithm 2, is evaluated every fifth slot and it counts the number of zeros and ones sent from the different radio link sets to make a decision whether to increase or decrease the transmission power of the UE or to let the transmission power remain the same. See the 3GPP document 25.214, section 5.1.2.2.2 and 5.1.2.2.3, for details regarding these two UE algorithms.

With increasing data rates offered specifically by base stations according to the above mentioned standards and also by wireless communication standards generally, the requirements on the computational resources for decoding and signal processing are high. If traffic is excessively high, the base station may simply get overloaded, not due to restrictions on the air interface but restrictions of the computational resources of the base station. As will be demonstrated in the following, prior art base stations adapted for operating in soft handover may in overload situations not respond in a suitable manner when a base station receives more data in uplink than what resources allow for.

### References

3GPP 25.214, “Technical Specification Group Radio Access Network—Physical Layer Procedures (FDD)”, Release 8.

3GPP 25.309, “Technical Specification Group Radio Access Network—FDD Enhanced Uplink—Overall Description—Stage 2”, Release 6.

### SUMMARY

Forthcoming releases of WCDMA will allow E-DCH to support even higher bandwidth, shorter delay, and quality of service applications etc. to meet the increased use of wireless internet. Having in mind the bursty characteristic of the traffic served by E-DCH, it would be preferable that Node-B would have hardware and/or software resources which could be shared between the users of the wireless network. Hereinafter, when the term Node-B resources is used, reference is made to both hardware and/ or software re- sources. However, according to the invention, it is acknowledged that Node-B can not be dimensioned such that “reserved Node-B resources” should correspond to the maximum number of supported users served by a Node-B, wherein each user utilizes a maximum rate. Such a solution would not be cost effective.

Various degrees of sharing can be imagined by the inventors of the present application, from solutions where Node-B resources can be pre-reserved to a specific user e.g. where Node-B pre-reserve Node-B resources against the forthcoming granted rate by the scheduler in advance. Another degree of sharing would be to share Node-B sources dependent on the outcome of the decoded E-DPCCH, e.g. whatever user that send data Node-B will assign Node-B resources to decode it. The latter solution does not require that a Node-B scheduler pre-reserves resources prior to granting rate to user but it is required that the scheduler does not allocate Mere than the maximum supported rate which the Node-B resources are capable to decode. In non TDMA WCDMA systems, which are the majority of the deployed WCDMA systems, the end users transmit simultaneously with different spreading codes in order to separate data from one another, and the end users have different spreading factors and transmit power dependent on desired user throughput. Node-B may receive data simultaneously from many users, and it is up to the scheduler in Node-B to reassure that the aggregated interference level is acceptable so that each user's granted rate also will be a rate which can be decoded in Node-B.

For the uplink, the amount of tolerable interference affects the common resource shared between the users, i.e. the total received power at the Node-B. Generally, it applies that the higher the data rate is, the larger is the required transmission power and thus the higher is the air-link resource consumption. To differentiate from the Node-B resource term defined above, in this document, the term air link resource is used further on in this document for the radio link resource.

It is understood that the present invention is not only related to WCDMA systems but also to other systems which are capable of soft handover or softer handover.

Therefore, it is a first object of the present invention to set forth a method for a base station adapted for operating in soft handover which quickly and efficiently adapts to overload situations caused by limits in computational processing power in the base station.

This object is achieved by the subject matter defined by claim 1, wherein there is provided a method for a first base station (BS1) adapted to receive uplink transmissions at transmission opportunities from a given user entity (UE); the base station (BS1) moreover being adapted for co-operating with a second base station (BS2) such that transmissions from a single user entity is partially received by the first base station (BS1) and partially received by the second base station (BS2), such transmissions also being denoted soft handover, at least. the first base station (BS1) controlling the power of the uplink transmission from the ser entity by transmitting a power up signal (UP) or a power down signal (DOWN).

The user entity is adapted to
when receiving power down signal (DOWN) from the first base station (BSI) and a power up signal (UP) from the second base station—or vice versa—adjusting the transmission power et least a subsequent transmission opportunity using a lower transmission power level,
when receiving a power up (UP) signal and no power down (DOWN) signal, adjusting the transmission power to a higher level,
when receiving a power down signal and no power up signal, adjusting the transmission power level to a lower level.

The method comprises the steps of detecting whether the following conditions I-III are all found to exist
I—whether a transmission from a given user entity is received on a transmission opportunity (10, 20),
II—whether an overload situation exists in the base station,
III—whether the base station is in a state of soft handover with regard to receiving an expected transmission from the given user entity, and if conditions I-III are all found to exist,
at least refraining (24) from issuing a power down (DOWN) signal,
wherein the refraining (24) from issuing a power down signal (DOWN) is performed although the signal to interference (SIR) level may be above a predefined first level normally giving rise to issuing a power down (DOWN) signal.

It is a second object of the present invention to set forth a base station and a method for a base station adapted for operating in soft handover which quickly and efficiently adapts to overload situations caused by limits in computational processing power in the base station.

This object has been achieved by the subject matter defined by claim 7, wherein a base station (BS1) is provided being adapted to receive uplink transmissions at scheduled transmission opportunities from a given user entity (UE), the base station (BS1)—denoted first base station (BS1) moreover being adapted for co-operating with a second base station (BS2)) such that transmissions from a single user entity is partially received by the first base station (BS1) and partially received by the second base station (BS2), such transmissions also being denoted soft handover.

The first base station (BS I) at least contributing controlling the power of the uplink transmission from the user entity by transmitting a power up signal (UP) or a power down signal (DOWN),

wherein the user entity is adapted to
when receiving a power down signal (DOWN) from the first base station (BSI) and a power up signal (UP) from the second base station—or vice versa adjusting the transmission power at least at a subsequent transmission opportunity using a lower transmission power level,
when receiving an UP signal and no power down (DOWN) signal, adjusting the transmission power to a higher level,
when receiving a power down (DOWN) signal and no power (UP) signal adjusting the transmission passive level to a lower level, wherein
   the first base station (BSI) comprises a scheduler (SCH) being adapted to detect whether the fallowing conditions I-III are all found to exist
I—whether a transmission from a given user entity is received on transmission opportunity (10, 20),
II—whether an overload situation exists in the base station,
III—whether the base station is in a state of soft handover with regard to receiving an expected transmission from the given user entity.

And if conditions I-III are all found to exist,
the base station (BS1) is at least refraining (24) from issuing a power down (DOWN) signal, wherein the refraining (24) from issuing a power down signal (DOWN) is performed although the signal to interference (S)R) level may be above a predefined first level normally giving rise to issuing a power down (DOWN) signal.

Further advantages will appear from the following detailed description of the invention.

### BRIEF DESCRIPTION OF THE DRAWINGS

FIG. 1 shows basic elements of a prior art HSUPA network and signaling,

FIG. 2 shows a hypothetic implementation, not forming part of the invention, where a maximum throughput limit is exceeded,

FIG. 3 shows another hypothetic implementation, not forming part of the invention, where a scheduler margin is used,

FIG. 4 shows a base station according to a first embodiment of the invention,

FIG. 5 is a first flow diagram pertaining to a method for a first embodiment of the invention,

FIG. 6 is second flow diagram pertaining to the method of the first embodiment of the invention,

FIG. 7 shows a possible. scenario concerning a user entity, a first cell and a second cell, wherein the entities operate according to the prior art, and

FIG. 8 shows the same conditions which apply for the scenario as FIG. 7 but where the method of the invention is applied.

### DETAILED DESCRIPTION

In WCDMA systems there is provided both an uplink power regulation mechanism (TPC) and a data rate regulation mechanism. The RNC determines which Node B, participating in a soft handover transmission from a divan user entity, is “serving node B”, while additional Node B's taking part in the soft handover transmission from the user entity are denoted non-serving Node B's. As regard the non-serving Node B's, restrictions apply for their data rate regulation. A non-serving Node B is only allowed to limit the uplink data rate from a UE, not to raise it. The serving Node B. on the other hand may both regulate the data rate up and down. As for regulating the transmission power from user entities the situation is more symmetrical, both serving and non-serving Node B's may (contribute) to regulate the power up and down, as explained in the foregoing.

In particular for such systems where such conflicts exist regarding asymmetric/symmetric regulation mechanisms pertaining to base stations proving soft handover, there may appear problems related to utilizing the hardware software in an optimum fashion.

For instance, the invention relates to the problem that will arise when a base station, e.g. a Node-B, receives more data in the uplink than what its (Node-B) computational resources allow for. More specifically, focus is on the situation where a received E-DPDCH packet will be discarded due to the latter situation, but the inner loop TPC will continue its normal operation. Two scenarios where this occurs are described below:

### First Scenario

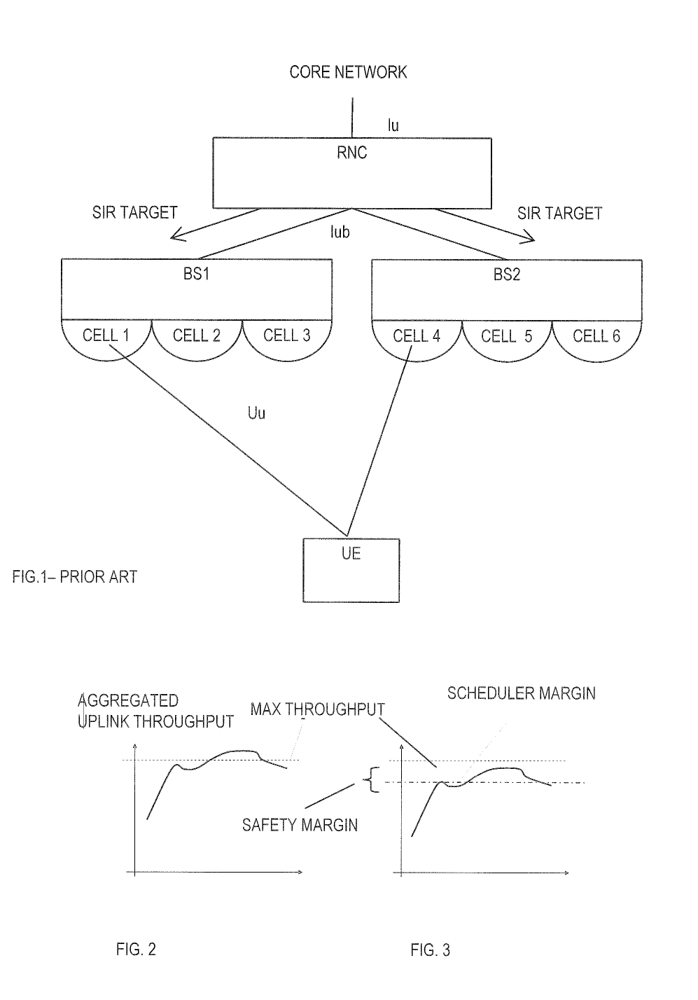

Assume a UE moves from one cell (Cell 1, FIG. 1) of one Node B towards a another cell (Cell 4, in FIG. 1) in another separate Node-B. Assume further that Cell 1 is the serving cell of the UE with only one radio-link in the active set. At a certain time, the RNC orders the UE to connect also to Cell 4 such that Cell 4 is added in the active set as non-serving. A Node-B resource overload situation can occur if now the UE transmits at a high pace until the Node-B can a relative grant to force the UE to decrease its throughput. Note that this is only possible if the overload is caused by interference. This is due to the requirement of 3GPP 25.309, which prevents other causes than interference problems as causes for sending relative grants.

More generally, according to 3GPP, document 25.309, non-serving Node-Bs are allowed to send “traffic rate down” commands (i.e. via the Enhanced Relative Grant Channel (E-RGCH) ordering its non-serving UEs to go down in rate on the E-RGCH) because of interference reasons only, and hence not because of lack of internal Node B processing resources. It should be noted that the “traffic rate down” commands are different from uplink transmission power control (TPC) commands being dealt with in the foregoing. As a consequence, when a non-serving Node-B can not decode data from a certain UE, which for instance is transmitting on a high, very hard- and/or software-processing consuming rate, Node B can not limit the UE's data rate to a data rate that Node B is capable of handling.

### Second Scenario

Assume UE 1, 2 and 3 transmit simultaneously and that UE 1 has been given a higher grant than UE 2, and UE 2 has been given a higher grant than UE 3.

Assume also that the accumulated throughput of UE 1, 2 and 3 is at the maximum which the Node-B can handle. Assume now that Node-B due to fairness reason, or any other reason would like to swap granted rates of UE 1 and UE 3, but UE 1 fails in decoding the grant. UE 1 will subsequently continue to transmit at the previous rate. This will lead to a Node-B resource overload situation in Node-B. It will be appreciated, that it is not certain whether Node-B will be able to decode any of the transmissions described in this scenario, since it depends on whether the air-link resource interference situation allows for it. Uplink scrambling codes are not orthogonal and interference between users exists.

To avoid a Node-B resource overload situations such as above, the Node-B scheduler could implement a scheduler margin in order to avoid this. By using a scheduler margin, it is meant that the scheduler will not allocate the maximum possible throughput which the Node-B resources are capable of.

FIG. 2 shows a hypothetical aggregated throughput over time when not using a scheduler margin. At a given level, the maximum throughput is reached and the aggregated air link resources, although existing, can not exceed the maximum throughput limited by the computational max throughput. FIG. 3 shows the use of scheduler safety margin. Instead of aiming at scheduling for the absolute maximum that Node B can handle processing wise Node B schedules for the maximum that the Node B can handle minus a “safety margin”. The scheduler operates such that once the scheduler margin in FIG. 3 is reached no further user entities are served by the base station.

As described in the two scenarios above, there will be occasions where the aggregated uplink throughput actually becomes larger than what was estimated using a given level of scheduling. It is understood that especially for the FIG. 3 solution, the safety margin will effectuate that the occasions where the Node B can not decode the data is avoided to a larger degree.

The safety margin does not have to be fixed, but can depend on the amount of active users etc. However, according to the invention, it is observed that when using a safety margin, the maximum throughput is lowered, which is not an optimum solution, especially when focus is on actual maximum throughput figures. It is noted, that Node-B resources shall also be capable of serving other tasks simultaneously, such as performance management operation and management tasks, NBAP (Node B Application Part—a signalling protocol responsible for the control of the Node B by the RNC) control signal handling tasks etc. which may also result in overload situations.

In conclusion, in a WCDMA system and similar systems, situations can and will occur where Node-B will not be capable of handling the aggregated E-DCH and similar traffic data.

### First Embodiment of the Invention

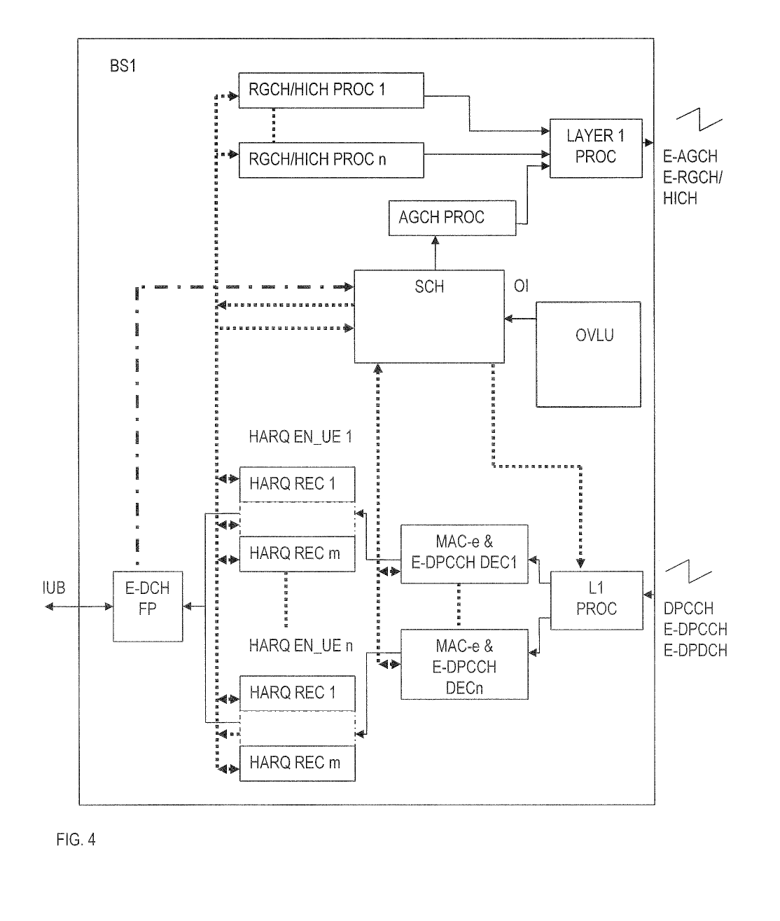

In FIG. 4, an exemplary base station BS1 according to the invention is shown, also denoted Node B, being capable of operating both as a serving base station and as a non-serving base station.

The base station comprises RGCH/HICH processing stages 1-n, RGCH/HICH PROC s 1-n, AGCH processing, AGCH PROC, a scheduler SCH, respective HARQ entities for user entities 1-n, HARQ EN_UE1 . . . UEn, each HARQ entity comprising a plurality of HARQ receivers, HARQ REC 1 . . . REC m—for receiving packets 1-m according to the HARQ process for each user entity. Node B moreover comprises Layer 1 processing means, LAYER 1 PROC, for communicating over E-AGCH and E-RGCH channels over the air interface, L1 processing Means, L1 PROC, for communicating over DPCCH. E-DPCCH and E-DPDCCH channels. Moreover, the base station comprises E-DPCH FP means for communicating over the IUB interlace. MAC-e EDPCCH decoding means 1-n is provided for HARQ entities for UE 1-n. According to the invention, the method steps concerning Node B according to the invention may be implemented as a program in the scheduler, SCH.

The base station moreover comprises a processing overload unit, OVLU, which senses whether an overload situation occurs in the Node B with regard to the computational processing. If E-DPDCH can not be decoded due to Node-B resource limitations, the overload unit transmits an overload indication OI to the scheduler.

According to the first embodiment of the invention, at successful decoding of E-DPCCH from a first E-DCH user where the user is in soft handover. Node-B investigates whether “a Node-B resource overload situation” exists, and upon such an event, Node-B shall according to the invention discard or prevent the decoding of the E-DPDCH from the first said E-DCH user.

Moreover, Node-B inhibits the transmission of UL TPC commands for the first said E-DCH user. With inhibit, reference is made to both of the following alternatives:
To avoid sending any feedback (DTX) to the user (preferred solution—first embodiment).
To send an UL TPC command ‘UP’.

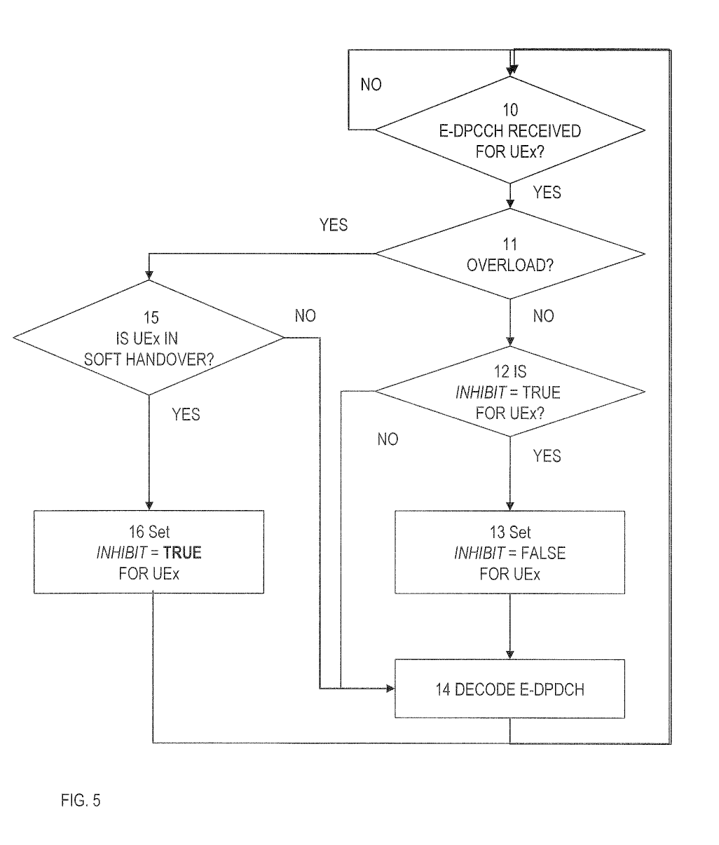

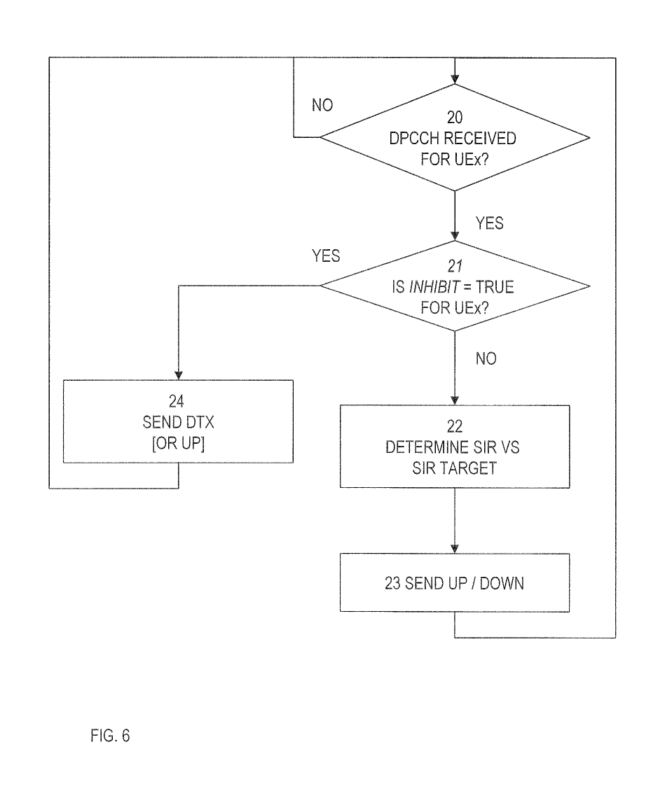

The inhibit flag) shall take place “as fast as possible” of the UL TPC command signaling. The inhibit flag shall last until the internal overload situation of Node-B is ceased, or until Node-B explicitly ceases the inhibit flag for the first said ue. The latter may be used in a situation where the Node-B overload condition lasts, but when Node-B wants to move the Inhibit condition from one E-DCH user to another E-DCH user. The following two flow diagrams of FIGS. 5 and 6 illustrate a preferred method for carrying out the invention in Node-B.

The first flow diagram refer to the E-DCH receive procedures. The second flow diagram shows a procedure running in parallel with the first flow diagram. The second flow diagram shows the behaviour of the UL TPC handling in the Node B according to an embodiment of the invention. Here, the Inhibit flag is used to determine whether to send a UL TPC command or not. Steps 20, 22 and 23 are also performed in the prior art.

Flow diagram of FIG. 5:

In this flow diagram, at step 10 Node-B awaits a successful decoding of an E-DPCCH for a given user entity denoted Uex.

In step Node-B checks if a Node-B resource !imitation exists.

If yes at step 11, step 15 continues.

In step 15, it is checked if UEx is in soft handover. If yes, step 16 continues. If no, the process continues to step 14.

In step 16, an Inhibit UL TPC notification for UEx is set. This information is stored.

If no, at step 11, step 12 continues to check if the Inhibit notification is set for UEx (set earlier).

If yes, at step 12, the processing continues at step 13 by ceasing the Inhibit notification for UEx, since the overload is no longer present.

If no, at step 12, the processing continues at step 14 by decoding the E-DPDCH (prior art).

The second flow diagram shows the UL TPC procedure in Node-B.

Steps 10 and 14 are also performed in the prior art.

Flow diagram of FIG. 6:

At step 20, Node-B awaits a reception of DPCCH for Uex.

At step 21, Node-B checks if Inhibit indication is TRUE for Uex.

If yes at step 21, processing continues at step 24 by sending a DTX to UEx.

If no at step 21, processing continues by determining whether estimated SIR is below or over SIR Target.

At step 23, processing continues by sending the result of the outcome at step 22 being either a DOWN or UP UL TPC command.

In other words there is provided:

A method for a first base station (BS1) adapted to receive uplink transmissions at transmission opportunities from a given user entity (UE); the base station (BS1) moreover being adapted for co-operating with a second base station (BS2) such that transmissions from a single user entity is partially received by the first base station (BS1) and partially received by the second base station (BS2), such transmissions also being denoted soft handover, at least the first base station (BS1) controlling the power of the uplink transmission from the user entity by transmitting a power up signal (UP) or a power down signal (DOWN).

The user entity is adapted to
when receiving a power down signal (DOWN) from the first base station (BS1) and a power up signal (UP) from the second base station—or vice versa—adjusting the transmission power at least a subsequent transmission opportunity using a lower transmission power level,
when receiving a power up (UP) signal and no power down (DOWN) signal, adjusting the transmission power to a higher level,
when receiving a power down signal and no power up signal, adjusting the transmission power level to a lower level.

The method comprises the steps of detecting whether the following conditions I-III are all found to exist
I—whether a transmission from a given user entity is received on a transmission opportunity (10, 20),
II—whether an overload situation exists in the base station,
III—whether the base station is in a state of soft handover with regard to receiving an expected transmission from the given user entity, and if conditions I-III are all found to exist,
at least refraining (24) from issuing a power down (DOWN) signal,
wherein the refraining (24) from issuing a power down signal (DOWN) is performed although the signal to interference (SIR) level may be above a predefined first level normally giving rise to issuing a power down (DOWN) signal.

In further advantageous alternatives of the first embodiment there is moreover provided a method, wherein when conditions I-III are all found to exist, no signal is transmitted, such that in the latter case a discontinued transmission opportunity, that is, a lacking response (DTX-24) may be detected at the user entity.

The overload situation in the first base station may amount to hardware and/ or software resources being limited in the base station such that decoding of traffic from user entities above a given rate is not possible in the base station.

According to one example, the base station is adapted to operate according to wideband code division multiplex access (WCDMA) scheme incorporating an enhanced dedicated channel (E-DCH).

The overload situation in the first base station may be caused by a decoding resource limitation for at least one given user entity having a non-serving relation to the first base station (BS1). However, the invention is not restricted to non-serving base station operation.

As is known from for instance WCDMA systems the first base station (BS1) may be adapted to respond to expected transmissions at given transmission opportunities (TTI) from a given user entity with an acknowledging signal (ACK), with a not (negative) acknowledging signal (NACK) or by refraining from responding (DTX) if no transmission is detected on a given scheduled transmission opportunity.

To summarize the apparatus being shown, according to the first embodiment, the method is implemented in a first base station.

The first base station (BSI) may comprise a scheduler (SCH) being adapted to detect whether the conditions I-III, mentioned above, are all found to exist.

The base station may further comprise an overload evaluation unit (OVLU) adapted to detect the overload situation in the base station. The overload situation in the first base station (BS1) could amount to hardware and/or software resources being limited in the first base station such that traffic beyond a given upper number of transmissions from user entities can not be processed by the first base station.

### Second Embodiment of the Invention

According to a further embodiment, also shown in FIG. 6, at step 24 instead of a DTX, an UP signal is issued.

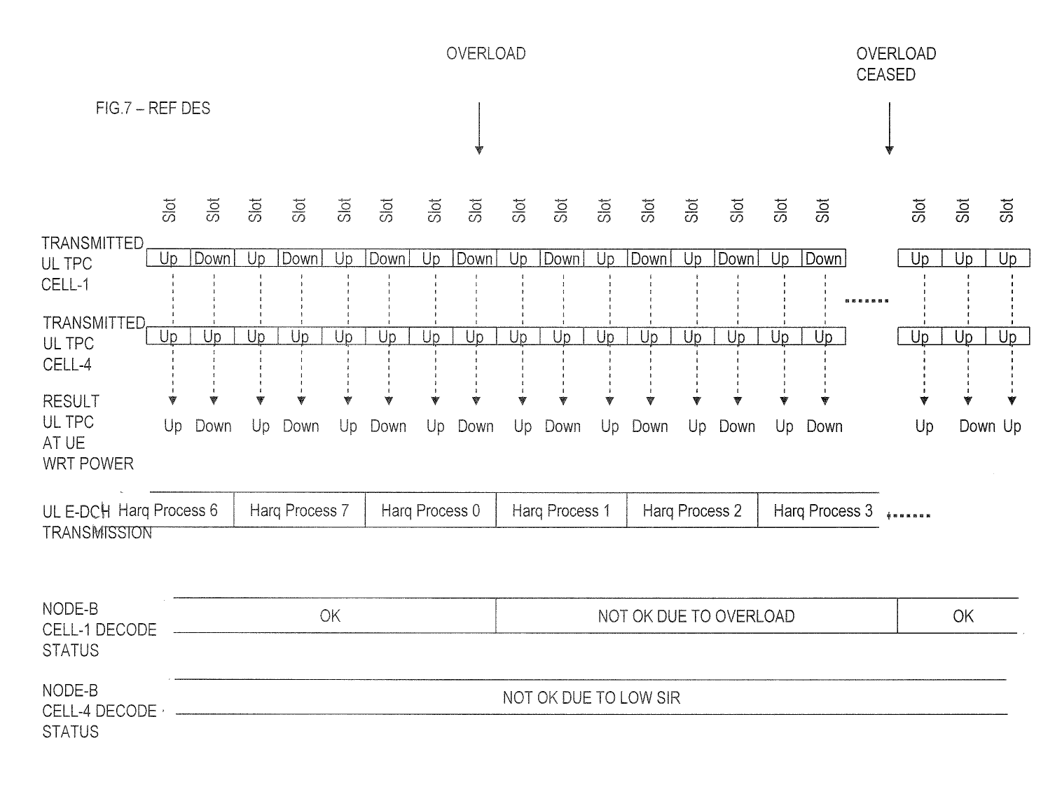

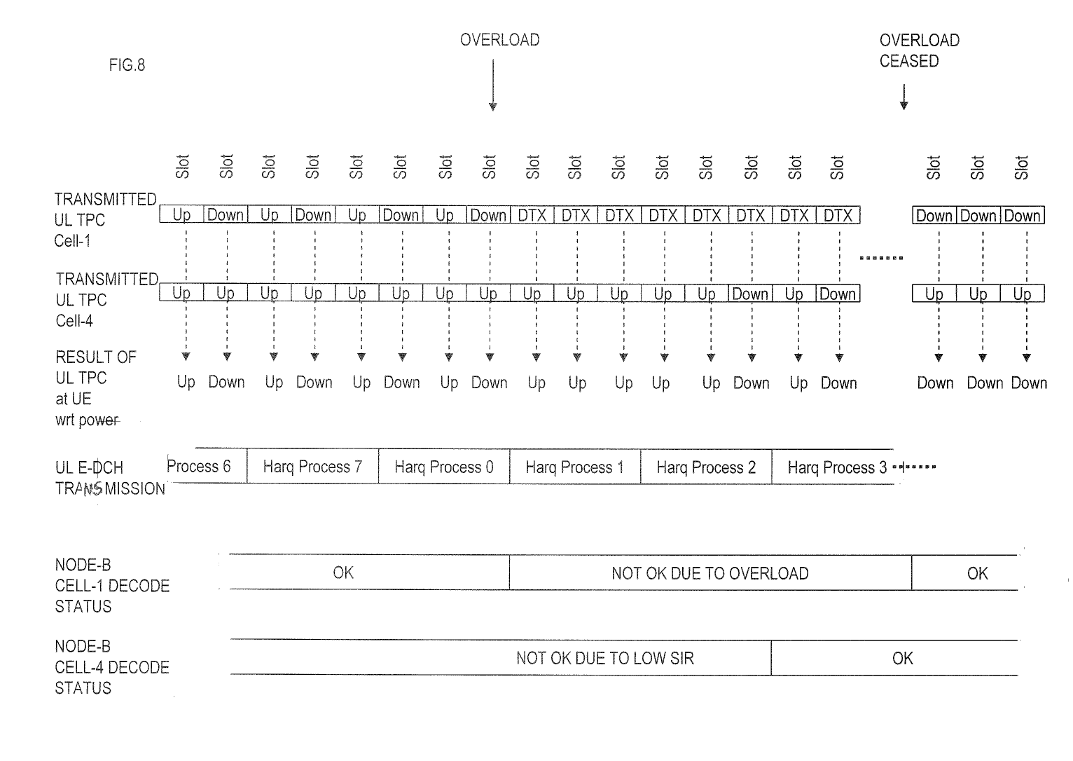

FIG. 8 shows an exemplary scenario, wherein a user entity, a first cell and a second cell, are provided and wherein the Node B operates according to the first embodiment of the invention. For comparison, FIG. 7 shows a possible scenario wherein the entities operate according to the prior art and wherein the conditions are the same as for the FIG. 8 scenario.

As shown in FIG. 8, if Node-B at Cell-A explicitly discard an E-DCH packet, it is very likely that the received power level at Cell-B is too low for Cell-B to be able to successfully decode the E-DCH packet. Further on. if Node-B of Cell-B sends an ‘UP’ command in order to increase the SIR level, Node-B of Cell-A will most likely send ‘DOWN’ which will have the dominant effect in the UE.

Dependent on whether the overload situation lasts at Cell-A with yet another discard of the E-DCH transmission for the particular user, the subsequent retransmission may result in the same negative outcome. if the overload lasts for a longer duration, it is likely that RNC changes the SIR target level at both Cell-A and Cell-B using the outer loop power control. This will improve the likelihood of reception at Cell-B which is positive during such conditions. But if the overload situation in Node-B occurs with a duration which is small compared to the pace at which the RNC control the SIR target level, e.g. short glitches of overload in Node-B, then the SIR Target change will come too late. E.g. the SIR Target will be set to a higher level than what is needed, and this will increase the total interference.

In comparison with the scenario shown in FIG. 7, corresponding to the prior art, the outcome will be that during a period of time, it will not be possible for any of the Node B's to decode the data from the UE—in Cell A because of overload and Cell B because of too low SIR. The situation will remain unfavourable until the overload situation in Cell A is over or until the RNC changes the SIR target (e.g. 500 milliseconds).

As seen in FIG. 8, where the invention is applied and the situation occurs where Cell A will not send any UL TPC command. This will make Cell B's UL TPC command actually taking control of the UEs power setting. This will in a few milliseconds raise the power in the UE so that the SIR in Cell B improves just enough so that the data the UE sends can be decoded in Node B.

As indicated, the embodiments of the invention quickly solves the situation where an overload appears in one cell by making the other cell take control of the UE and decode its data.

As explained above, a main benefit of E-DCH is the soft handover feature, which comprises the two components power control from each involved Node-B and data reception at each involved Node-B.

The invention may be implemented in the Node-B, according to the 3GPP HSUPA suite of standards among other specified above. However, the invention may also be implemented in other types of base stations featuring soft handover.

As appears from above, one advantage of the invention is that a temporary Node-B resource overload situation in a first Node-B, which serves a UE in soft handover, will allow for second Node-B to take control over the UE's transmission power level, in such a way that the second Node-B will be able to decode the transmission from the UE during the time period which the overload lasts in the said first Node-B.

### Abbreviations

3GPP Third Generation Partnership Project

ACK Acknowledgement

CPU Central Processing Unit

DCH Dedicated Channel

DPCCH Dedicated Physical Control Channel

DPCH Dedicated Physical Channel

E-DCH Enhanced Dedicated Channel

E-DPCCH Enhanced UL Dedicated Physical Control Channel

E-DPDCH Enhanced UL Dedicated Physical Data Channel

EUL Enhanced Uplink, also called High Speed Uplink Packet Access (HSUPA)

E-HICH Enhanced HARQ Indication Channel

E-RGCH Enhanced Relative Grant Channel

F-DPCH Fractional Dedicated Physical Channel

HARQ Hybrid Automatic Repeat Request

ITU International Telecommunication Union

Iu The name of the interface between the core network and the RNC

Iub The name of the interface between the RNC and the Node-B

NACK Negative Acknowledgement

RNC Radio Network Controller

SIR Signal Interference Ratio

TPC Transmission Power Control

UE User Equipment

UL Uplink

Uu The Name of the Interface between the Node-B and the UE

WCDMA Wideband Code Division Multiple Access

1. A method for a first base station (BS1) adapted to receive uplink transmissions at transmission opportunities from a given user entity (UE); the base station (BS1) moreover being adapted for co-operating with a second base station (BS2) such that transmissions from a single user entity is partially received by the first base station (BS1) and partially received by the second base station (BS2), such transmissions also being denoted soft handover, at least the first base station (BS1) controlling the power of the uplink transmission from the user entity by transmitting a power up signal (UP) or a power down signal (DOWN), wherein the user entity is adapted to: (a) when receiving a power down signal (DOWN) from the first base station (BS1) and a power up signal (UP) from the second base station—or vice versa adjusting the transmission power at least a subsequent transmission opportunity using a lower transmission power level, (b) when receiving a power up (UP) signal and no power down (DOWN) signal, adjusting the transmission power to a higher level, (c) when receiving a power down signal and no power up signal, adjusting the transmission power level to a lower level, the method comprising:
detecting whether the following conditions I-III are all found to exist
(I) whether a transmission from a given user entity is received on a transmission opportunity,
(II) whether an overload situation exists in the base station,
(III) whether the base station is in a state of soft handover with regard to receiving an expected transmission from the given user entity; and
refraining from issuing a power down (DOWN) signal in response to detecting that conditions I-III are all found to exist, wherein
the refraining from issuing a power down signal (DOWN) is performed although the signal to interference (SIR) level may be above a predefined first level normally giving rise to issuing a power down (DOWN) signal.

2. The method according to claim 1, wherein, when conditions I-III are all found to exist, a power up (UP) signal is issued or no signal is transmitted, such that in the latter case a discontinued transmission opportunity may be detected at the user entity.

3. The method according to claim 1, wherein the overload situation in the first base station amounts to hardware and/ or software resources being limited in the base station such that decoding of traffic from user entities above a given rate is not possible in the base station.

4. The method according to claim 1, wherein the base station is adapted to operate according to wideband code division multiplex access (WCDMA) scheme incorporating an enhanced dedicated channel (E-DCH).

5. The method according to claim 4, wherein the overload situation in the first base station is caused by a decoding resource limitation for at least one given user entity having a non-serving relation to the first base station (BS1).

6. The method according to claim 1, wherein
the first base station (BS1) moreover being adapted to respond to expected transmissions at given transmission opportunities (TTI) from a given user entity with an acknowledging signal (ACK), with a not acknowledging signal (NACK) or by refraining from responding (DTX) if no transmission is detected on a given scheduled transmission opportunity.

7. A first base station (BS1) adapted to receive uplink transmissions at scheduled transmission opportunities from a given user entity (UE), the first base station (BS1) moreover being adapted for co-operating with a second base station (BS2)) such that transmissions from a single user entity is partially received by the first base station (BSI) and partially received by the second base station (BS2), such transmissions also being denoted soft handover, the first base station (BS1) at least contributing controlling the power of the uplink transmission from the user entity by transmitting a power up signal (UP) or a power down signal (DOWN), wherein the user entity is adapted to: (a) when receiving a power down signal (DOWN) from the first base station (BS1) and a power up signal (UP) from the second base station—(or vice versa-), adjusting the transmission power at least at a subsequent transmission opportunity using a lower transmission power level, (b) when receiving an UP signal and no power down (DOWN) signal, adjusting the transmission power to a higher level, and (c) when receiving a power down (DOWN) signal and no power (UP) signal, adjusting the transmission power level to a lower level,
the first base station (BSI) comprising a scheduler (SCH) being adapted to detect whether the following conditions I-III are all found to exist
(I) whether a transmission from a given user entity is received on a transmission opportunity,
(II) whether an overload situation exists in the base station, and
(III) whether the base station is in a state of soft handover with regard to receiving an expected transmission from the given user entity, and if conditions I-III are all found to exist,
the base station (BS1) at least refraining from issuing a power down (DOWN) signal, wherein the refraining from issuing a power down signal (DOWN) is performed although the signal to interference (SIR) level may be above a predefined first level normally giving rise to issuing a power down (DOWN) signal.

8. The base station according to claim 7, wherein when conditions I-III are all found to exist, a power up (UP) signal is issued or no signal is transmitted, such that in the latter case a discontinued transmission opportunity, may be detected at the user entity.

9. The base station according to claim 7, wherein the overload situation in the first base station (BS1) amounts to hardware and/or software resources being limited in the first base station such that traffic beyond a given upper number of transmissions from user entities can not be processed by the first base station.

10. The base station according to claim 7, wherein the base station further comprises an overload evaluation unit (OVLU) adapted to detect the overload situation in the base station.

11. The base station according to claim 7, wherein the base station is adapted to operate according to a wideband code division multiplex access (WCDMA) scheme comprising an enhanced dedicated channel (E-DCH).

12. Base The base station according to claim 7, wherein
the first base station (BS1) moreover being adapted to respond to expected transmissions at given transmission opportunities (TTI) from a given user entity with an acknowledging signal (ACK), with a not acknowledging signal (NACK) or by refraining from responding (DTX) if no transmission is detected on a given scheduled transmission opportunity.
